(19) United States
(12) Patent Application Publication
(10) Pub. No.: US 2016/0021270 A1
(43) Pub. Date: Jan. 21, 2016

(54) IMAGE READING DEVICE

(71) Applicants: KABUSHIKI KAISHA TOSHIBA, Tokyo (JP); TOSHIBA TEC KABUSHIKI KAISHA, Tokyo (JP)

(72) Inventor: Naoyuki Misaka, Mishima-shi (JP)

(21) Appl. No.: 14/333,563

(22) Filed: Jul. 17, 2014

(51) Int. Cl. H04N 1/00; H04N 1/10; H04N 1/401

(52) U.S. Cl. CPC H04N 1/00708; H04N 1/401; H04N 1/00689; H04N 1/00692; H04N 1/00912; H04N 1/1061; H04N 1/00551; H04N 2201/0081

(57) ABSTRACT

According to one embodiment, an image reading device includes: an open-close detection unit which detects opening and closing of a cover unit; a document presence-absence detection unit which detects the presence or absence of a document in the sub scanning direction of the document placed on the document table glass; a reference signal generation unit which generates a reference signal for shading correction used for normalization of an output signal from a line sensor which reads the document placed on the document table glass; and a document size finalizing unit which finalizes a document size, based on a target to be detected based on the output signal in a document main scanning direction of the line sensor that is shading-corrected with the reference signal generated at a timing in the course of closure of the cover unit, and on document presence-absence information from the document presence-absence detection unit.

### FIELD

Embodiments described herein relate generally to a technique of automatically detecting the document size of a document to be read in an image reading device.

### BACKGROUND

According to the related art, an image reading device includes an automatic document size detection unit which automatically detects the document size of a document placed on a document table glass (referred to as a platen glass) where a document is to be placed.

The automatic document size detection unit employs a system in which a scanner unit including a CCD line sensor or the like is slightly moved in a sub scanning direction, thereby detecting the document size in a main scanning direction. In this case, the size of the document in the sub scanning direction is detected by a photosensor arranged below the platen glass. In this detection system, both in the course of an operation of closing an open-close cover (referred to as a platen cover) that covers the platen glass in an openable and closable manner and in the state where the platen cover is closed, with the document placed on the platen glass, a document lighting light source provided in the scanner unit is turned on and the scanner unit is moved by a predetermined distance in the sub scanning direction, thus reading an image with the CCD line sensor.

If the image reading device using the system in which the scanner unit is moved to detect the document size is arranged in a surrounding environment where external light enters the platen glass in the image reading device, the external light from the surroundings may enter the platen glass in the course of the closure of the platen cover, influencing the reading of the document size.

Thus, it is desired that the influence of the external light from the surroundings should be reduced when detecting the document size.

### DESCRIPTION OF THE DRAWINGS

FIG. 1 is a plan view showing an embodiment of an image reading device.

FIG. 2 is a front view of FIG. 1, showing the state where a platen cover is opened.

FIG. 3 is a schematic view of an open-close sensor which detects opening and closing of the platen cover.

FIG. 4 is a front view of the image reading device, showing the state where the platen cover is closed.

FIG. 5 shows the relation between the opened or closed state of the platen cover and the output from the open-close sensor.

FIG. 6 shows the position where a sensor for detecting the document size is arranged.

FIG. 7 is a block diagram showing the hardware configuration of the image reading device.

FIG. 8 is a flowchart showing the operation of detecting the document size with the hardware configuration.

FIG. 9 shows luminance in the main scanning direction with respect to a read signal and a black reference signal for shading correction.

FIG. 10 is a graph in which the read signal is corrected based on the black reference signal for shading correction and in which a detection threshold is set.

FIG. 11 is a flowchart showing the operation of detecting the document size according to another embodiment.

### DETAILED DESCRIPTION

In general, according to one embodiment, in an image reading device, a document placed on a document table glass is read by a line sensor while a scanner unit is moved in a sub scanning direction.

The image reading device includes: a cover unit which is mounted in an openable and closable manner on a document table glass and holds a document on the document table glass while a scanner unit is moved in a sub scanning direction; an open-close detection unit which detects opening and closing of the cover unit; a document presence-absence detection unit which detects the presence or absence of a document in the sub scanning direction of the document placed on the document table glass; a reference signal generation unit which generates a reference signal for shading correction used for normalization of an output signal from a line sensor which reads the document placed on the document table glass; and a document size finalizing unit which finalizes a document size, based on a target to be detected based on the output signal in a document main scanning direction of the line sensor that is shading-corrected with the reference signal generated at a timing in the course of closure of the cover unit, and on document presence-absence information from the document presence-absence detection unit.

Hereinafter, an image reading device according an embodiment will be described in detail with reference to the drawings.

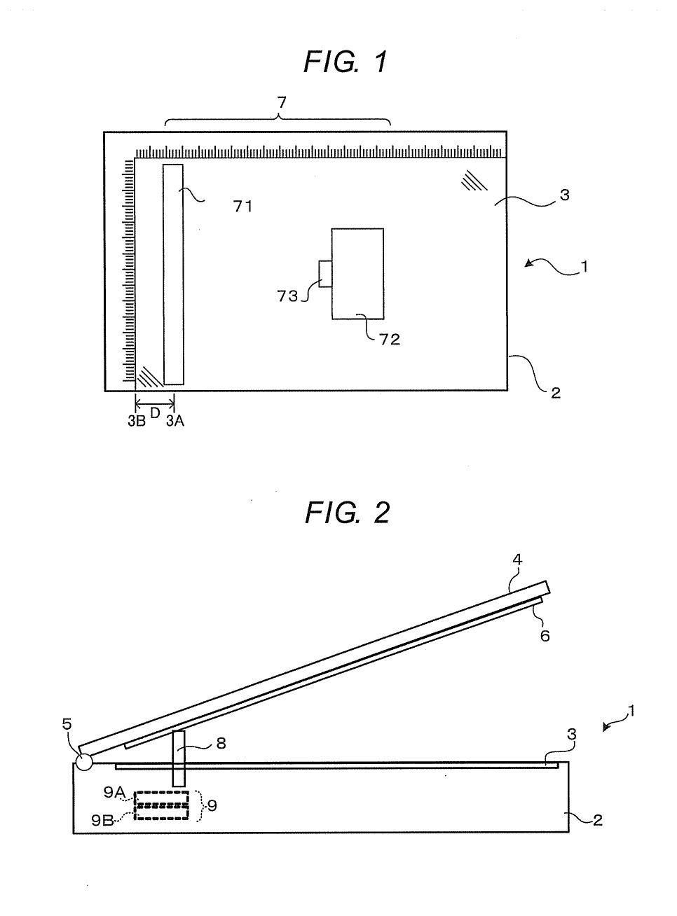

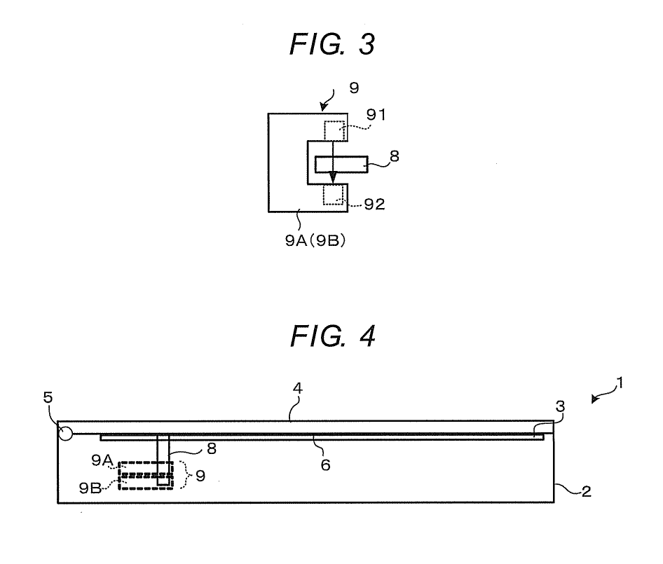

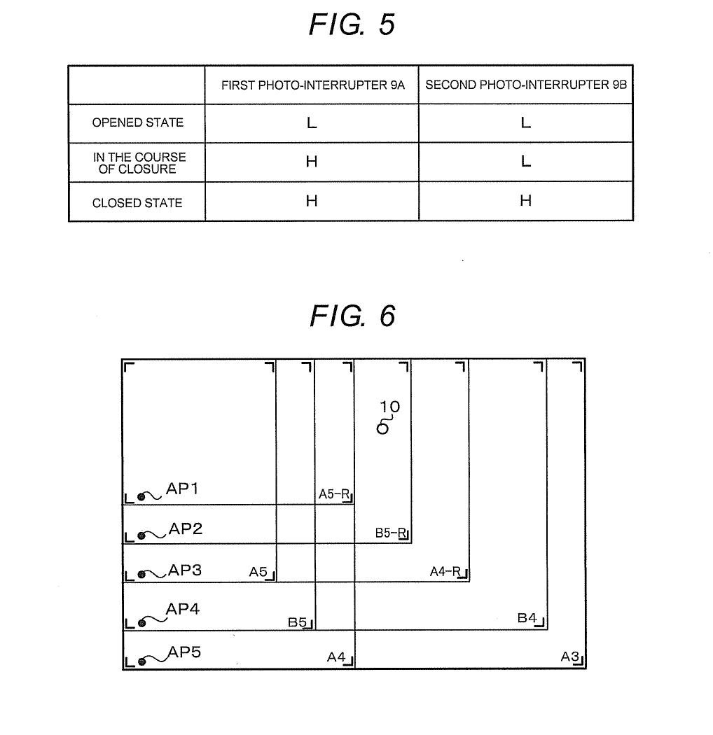

FIG. 1 is a plan view of an embodiment of the image reading device. FIG. 2 is a front view of FIG. 1, showing the state where a platen cover is opened. FIG. 3 is a schematic view of an open-close detection sensor of the platen cover provided in the image reading device of FIG. 2. FIG. 4 is a front view of the image reading device, showing the state where the platen cover is closed. FIG. 5 shows the relation between the opened or closed state of the platen cover and the output from the open-close sensor. FIG. 6 shows the position where an APS sensor for detecting the document size is arranged.

In an image reading device 1 of the embodiment a document table glass (platen glass) 3 is mounted on the top side of a reading device main body 2. On the reading device main body 2, an open-close cover (platen cover) 4 for covering the platen glass 3 is mounted in an openable and closable manner via a hinge member 5. A white document pressing member 6 is provided on the bottom side of the platen cover 4.

A scanner unit 7 is arranged inside the reading device main body 2.

The scanner unit 7 includes a reading carriage 71 equipped with a light source (not shown) and a mirror (not shown) or the like, an image reading line sensor (not shown) covered by a cover 72, a lens 73 which images an image read by the scanner unit 7 onto the image reading line sensor, and the like. In FIG. 1, the left-right direction in which the carriage 71 moves is referred to as a sub scanning direction, and the up-down direction is referred to as a main scanning direction.

The reading carriage 71 stands by at a standby position 3A shown in FIG. 1. If the left end of the platen glass 3 is a document reading forward end position 3B, the standby position 3A is a position that is shifted from the document reading forward end position 3B by a distance D in the sub scanning direction.

In the state where the carriage 71 is held at the standby position 3A, switch signals corresponding to the state where the platen cover 4 is opened and the state where the platen cover 4 is closed are read at this standby position. To detect the opened or closed state of the platen cover 4, a platen lever 8 which moves up and down with the open-close operation of the platen cover 4, and an open-close sensor 9 including two up and down units, that is, a first photo-interrupter 9A and a second photo-interrupter 9B, are combined to detect the open-close position of the platen cover 4, and image reading to detect the document size is carried out.

In FIG. 2, the platen lever 8 is situated at an uppermost position in the state where the platen cover 4 is opened. In this state, the platen lever 8 is retracted from the optical path of the first photo-interrupter 9A of the open-close sensor 9 and from the optical path of the second photo-interrupter 9B. As shown in FIG. 3, in the open-close sensor 9, when the optical path between a light projecting unit 91 and a light receiving unit 92 which are opposite each other is interrupted by the platen lever 8, the light receiving unit 92 outputs a signal “H” due to a change in output voltage. Meanwhile, when the platen lever 8 is retracted from the optical path and the light receiving unit 92 receives the light from the light projecting unit 91, the light receiving unit 92 outputs a signal “L” due to a change in output voltage.

Therefore, in the state where the platen cover 4 is opened as shown in FIG. 2, both the first photo-interrupter 9A and the second photo-interrupter 9B output a signal “L”.

Next, when the platen cover 4 is turned in the closing direction from the opened state of FIG. 2 in the state where a document is placed at a predetermined position on the platen glass, the platen lever 8 is pushed down by the platen cover 4. In the course of the closure of the platen cover 4, the platen lever 8 moves downward and interrupts the optical path of the first photo-interrupter 9A. The output signal from the first photo-interrupter 9A switches from “L” to “H”. In this state, light may enter a portion of the platen glass 3 where the document is not placed.

When the platen cover 4 is turned further in the closing direction and reaches the closed position, the platen lever 8 interrupts the optical path of the second photo-interrupter 9B while maintaining the interruption of the optical path of the first photo-interrupter 9A. The output signal from the second photo-interrupter 9B switches from “L” to “H”. FIG. 5 shows the relation between the open-close position of the platen cover 4 and the output signals of the first photo-interrupter 9A and the second photo-interrupter 9B.

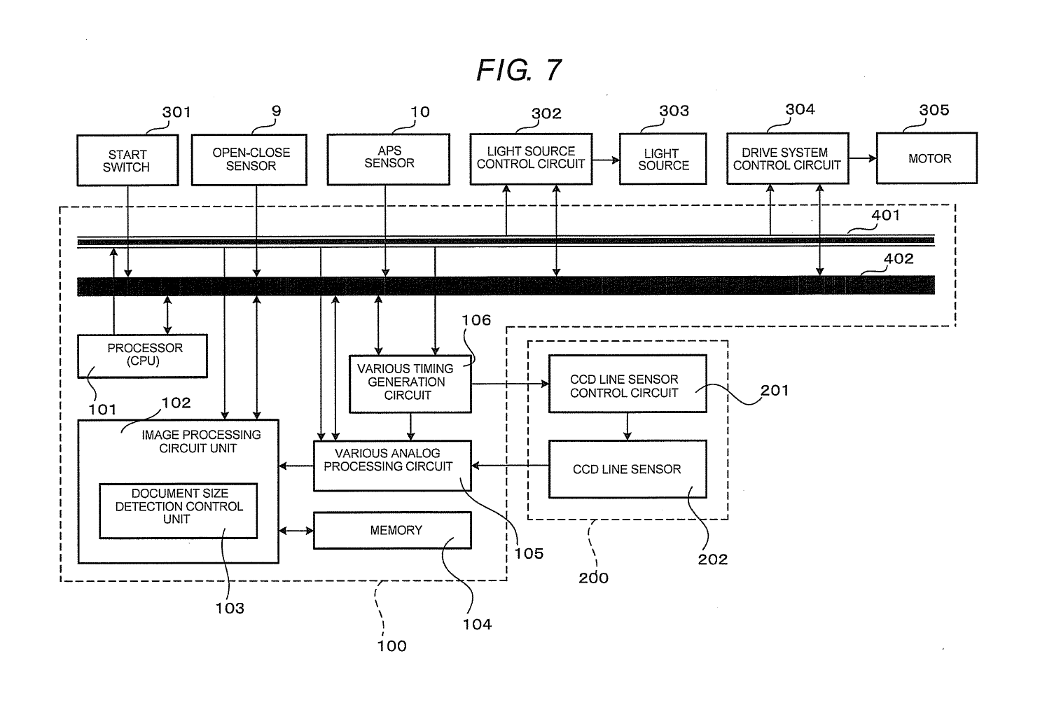

FIG. 6 is an explanatory view of the document size detection position. FIG. 7 is a block diagram showing the hardware configuration of the document reading device 1. As an example, the case of detecting A-type document sizes (A3, A4, A5, B4, B5) will be described.

By the line sensor for reading the document, the size in the direction of document width (main scanning direction), which is the vertical direction in FIG. 6, is detected. In FIG. 6, symbols AP1 to AP5 denote document size detection points in the main scanning direction. The average value of the respective detection points in the main scanning direction in the state where the platen cover 4 is opened is calculated and stored in a memory 104.

Next, the average value of the respective detection points in the main scanning direction in the state where the platen cover 4 is closed is calculated and stored in the memory 104. The average values of the respective detection points in the main scanning direction in the state where the platen cover 4 is opened and in the state where the platen cover 4 is closed are compared, and if there is a large difference between the values, it is determined that there is no document in that place. Meanwhile, if the difference is small, it is determined that there is a document in that place. Based on this result, the size in the direction of document width is detected. Also, the threshold for the determination can be arbitrarily set.

Next, the size in the direction of document length (sub scanning direction), which is the horizontal direction in FIG. 6, is detected. In FIG. 6, the position where a document size detection sensor (APS sensor) 10 is arranged is the document size detection point in the sub scanning direction. For example, the document sizes A4-R and A5 cannot be finalized simply by detection in the main scanning direction, which is the direction of document width. In this case, the result of detection in the sub scanning direction by the APS sensor 10 is combined to detect the size. As a detection method, the output from the APS sensor 10 in the state where the platen cover 4 is opened is stored in the memory 104. The results of the determination on the detection points AP1 to AP5 in the main scanning direction and the result of the determination by the APS sensor 10 are combined to finalize a document size.

In FIG. 7, the document reading device 1 includes a control unit 100, an image reading unit 200, a start switch 301, the open-close sensor 9, the APS sensor 10, a light source control circuit 302, a light source 303, a drive system control circuit 304, and a motor 305 which drives the scanner unit 7. Signals from the start switch 301, the open-close sensor 9 and the APS sensor 10 are outputted to a data bus 402. The light source control circuit 302 and the drive system control circuit 304 transmit and receive signals to and from the data bus 402. The light source control circuit 302 and the drive system control circuit 304 also acquire signals from an address bus 401.

When the start switch 301 is turned on, the light source control circuit 302 turns on the light source 303 of the scanner unit 7, and the drive system control circuit 304 turns on the scanner motor 305 of the scanner unit 7, thereby starting the scanning operation of the scanner unit 7. Also, a signal from the open-close sensor 9 detecting the open-close operation of the platen cover 4 and a detection signal from the APS sensor 10 are stored in the memory 104, and the document size is detected based on the length of the document in the main scanning direction that is read by a CCD line sensor 202.

The control unit 100 includes a processor 101 such as a CPU which controls the entirety of the image reading device, an image processing circuit unit 102 having a document size detection control unit 103, the memory 104, a various analog processing circuit 105, and a various timing generation circuit 106.

The processor 101, the image processing circuit unit 102, the various analog processing circuit 105, and the various timing generation circuit 106 transmit and receive signals to and from the data bus 402. The processor 101 transmits signals to the address bus 401. The various analog processing circuit 105 and the various timing generation circuit 106 acquire signals from the address bus 401.

In the image reading unit 200, a CCD line sensor control circuit 201 controls the CCD line sensor 202. A read signal read by the CCD line sensor 202 is outputted to the various analog processing circuit 105, and the read signal that is converted to a digital signal is outputted to the image processing circuit unit 102. The CCD line sensor control circuit 201 causes the CCD line sensor 202 to carryout reading at a reading timing generated by the timing generation circuit 106. Then, the various analog processing circuit 105 is made to carry out processing of the read signal at the generated timing. The image processing circuit unit 102 detects the document size with the document size detection control unit 103, based on the digitally converted read image and the data stored in the memory 104.

The various analog processing circuit 105 has a shading correction unit which carries out shading correction used for normalization, for example, with respect to the output signal from the CCD line sensor. The shading correction unit continues to acquire a reference signal for shading correction on a predetermined cycle outputted from the various timing generation circuit 106. The reference signal for shading correction may include a white reference signal and a black reference signal. In this embodiment, the white reference signal and the black reference signal are generated by a reference signal generation unit in the various analog processing circuit 105.

Then, the document size detection control unit 103 acquires the white reference data for shading correction from the reference signal generation unit in the state where the platen cover 4 is opened. When the platen cover 4 is half closed, the document size detection control unit 103 acquires the black reference data for shading correction from the reference signal generation unit and uses the data for finalization of the document size.

That is, in this embodiment, only the white reference data for shading correction is acquired before the document size detection operation, and the black reference data for shading correction is acquired when it is not the state where the platen cover 4 is closed.

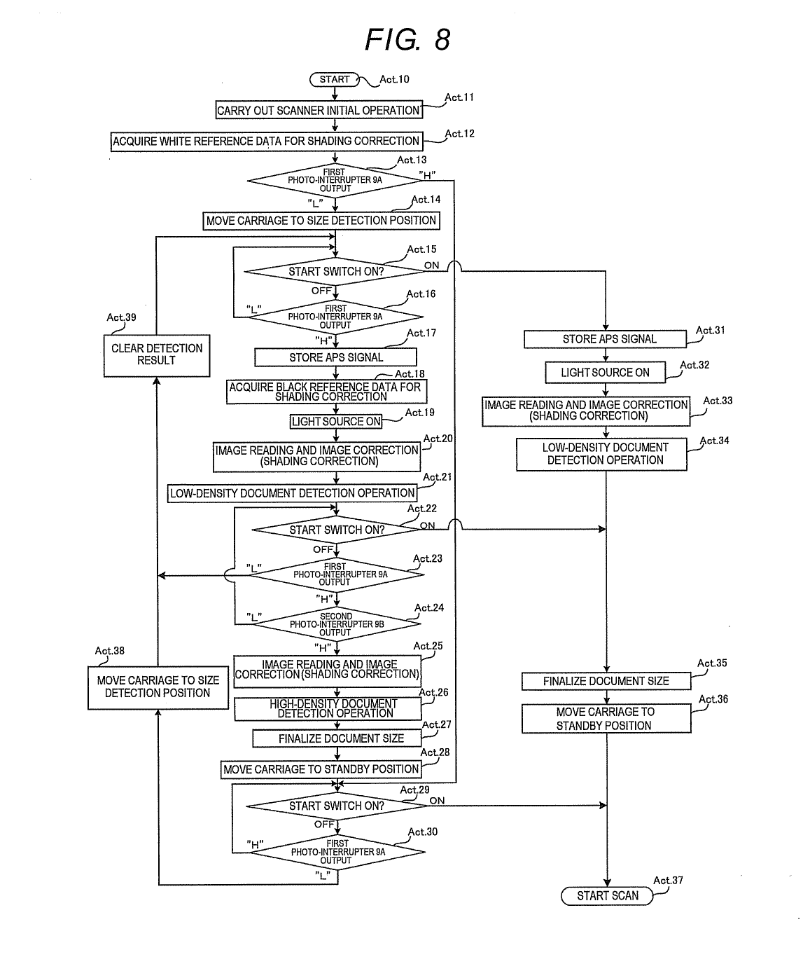

The document size detection operation will be described with reference to the flowchart of FIG. 8.

In Act 10, the document size detection operation is started. In Act 11, an initial operation of the scanner is carried out (Act 11) and the processing proceeds to Act 12. The initial operation of the scanner may include, for example, adjustment of the reference position, adjustment of the amount of light of the light source 303, adjustment of the CCD output, and the like.

In Act 12, acquisition of the white reference data for shading correction is executed for size detection. In Act 12, only the white reference data which is necessary when carrying out shading correction is acquired and stored in the memory 104. The light source 303 is turned on when acquiring the white reference data, and turned off after the acquisition of the data.

In Act 13, whether the output from the first photo-interrupter 9A is “H” or “L” is checked, thereby determining the position of the platen cover 4. If the output is “H”, the platen cover 4 is closed. Therefore, the document size detection operation cannot be carried out and consequently the processing proceeds to Act 29. If the output is “L”, the platen cover 4 is opened. Therefore, the processing proceeds to Act 14.

In Act 14, the carriage 71 is moved to the document size detection position and the processing then proceeds to Act 15.

In Act 15, whether the start switch 301 is on or off is checked. If the start switch is off, the processing proceeds to Act 16, where if the output signal from the first photo-interrupter 9A turns “H”, the processing then proceeds to Act 17. Meanwhile, if, for example, the start switch 301 turns on while waiting for the output signal from the first photo-interrupter 9A to turn “H”, the processing proceeds to Act 31. That is, detecting the half-open state in Act 16 from the state where the platen cover 4 is opened (act 13) can mean that a document is placed on the platen glass 3. Therefore, if the output signal from the first photo-interrupter 9A changes from “L” to “H” in Act 16, the document size detection operation is executed in Acts 17 to 21.

In Act 17, the presence or absence of a document in the sub scanning direction on the platen glass 3 is checked based on the output result from the APS sensor 10, and the detected APS signal is stored in the memory 104. The processing then proceeds to Act 18.

In Act 18, the black reference data for shading correction is acquired and stored in the memory 104 in the state where the light source 303 is off. The processing then proceeds to Act 19. The black reference data for shading correction is acquired by the CCD line sensor 202.

In Act 19, the light source 303 is turned on and the processing then proceeds to Act 20.

In Act 20, the image reading operation and the shading correction are carried out, and the data of each document position in the main scanning direction of AP1 to AP5 shown in FIG. 6 is acquired and stored in the memory 104. The processing then proceeds to Act 21. In the image reading operation for detection of the document size, the carriage 71 is moved in the sub scanning direction and the image is read by the CCD line sensor 202, as described above.

In Act 21, the presence or absence of a low-density document at each document position in the main scanning direction of AP1 to AP5 (low density detection information) is detected and the processing then proceeds to Act 22. In Act 21, since the illuminating light from the light source 303 illuminates the platen glass 3, the document face placed on the platen glass 3 has a high luminance and therefore the document face has a low density. As the low density detection operation in Act 21 ends, the light source 303 is turned off.

In Act 22, whether the start switch 301 is on or off is checked. If the start switch is on, the processing proceeds to Act 35, whereas if the start switch is off, the processing proceeds to Act 23.

In Act 23, whether the output from the first photo-interrupter 9A is switched to “L” or the “H” state is maintained is checked. If the output is switched to “L”, that is, if the platen cover 4 is returned to the open position in the course of closure, the processing proceeds to Act 39. Meanwhile, if the “H” state is maintained, the processing proceeds to Act 24.

In Act 24, whether the output from the second photo-interrupter 9B is “L” or “H” is checked. If the output from the second photo-interrupter 9B is “L”, it is determined that the platen cover 4 is yet to reach the closed position and the processing returns to Act 22, where if the output from the second photo-interrupter 9B turns “H”, the processing proceeds to Act 25.

In Act 25, a second round of image reading and image correction (shading correction) is carried out and the processing then proceeds to Act 26.

In Act 26, the present or absence of a high-density document at each position of AP1 to AP5 (high density detection information) is detected and the processing then proceeds to Act 27. That is, the platen cover 4 is closed and the image read by the CCD line sensor 202 has a high density within the document range and a low density outside the document range.

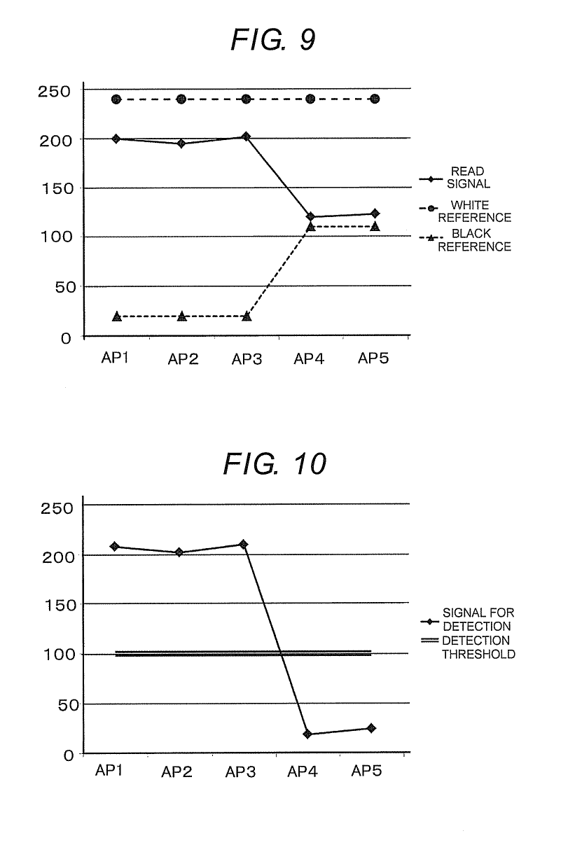

In Act 27, the document size is finalized, based on the APS signal acquired in Act 17, the low density detection information acquired in Act 21 and the high density detection information acquired in Act 26. The processing then proceeds to Act 28. The finalization of the document size will be described with reference to FIGS. 9 and 10 after the overall explanation of this flowchart.

In Act 28, the carriage 71 is moved to the standby position and the processing then proceeds to Act 29.

In Act 29, if the start switch 301 is turned on, the processing proceeds to Act 39 to start scanning since the document size is finalized. If the start switch 301 is maintained in the off state, the processing proceeds to Act 30.

In Act 30, if the output from the first photo-interrupter 9A is maintained as “H”, the operation waits for the start switch 301 to turn on. If the output from the first photo-interrupter 9A is changed from “H” to “L”, that is, if the platen cover 4 is opened, the processing proceeds to Act 38.

In Act 38, the carriage 71 is moved to the document size detection position again and the processing then proceeds to Act 39.

In Act 39, the result of the detection is cleared and the processing returns to Act 15.

Back to Act 13, if the platen cover 4 is half closed and the output from the first photo-interrupter 9A turns “H” before the document size is finalized, the operation waits until the start switch 301 to start reading is turned on in Act 29 and the scanning operation is then started in Act 37.

Also, back to Act 15, if the start switch 301 to read the document is turned on before the document size is finalized, the processing proceeds to Act 31 and the operations of Acts 31 to 34 are carried out in the state where the platen cover 4 is opened. In Acts 31 to 34, similar processing to Acts 17 to 21 is executed and the processing then proceeds to Act 35.

In Act 35, the document size is finalized, based on the low-density document detection information (act 34) and the APS signal (Act 31). The processing then proceeds to Act 36.

In Act 36, the carriage 71 is moved to the standby position. Scanning is started in Act 37.

Meanwhile, if the start switch 301 is turned on in Act 22, the processing proceeds to Act 35, where the document size is finalized, based on the APS signal (Act 17) and the low-density document information (Act 21).

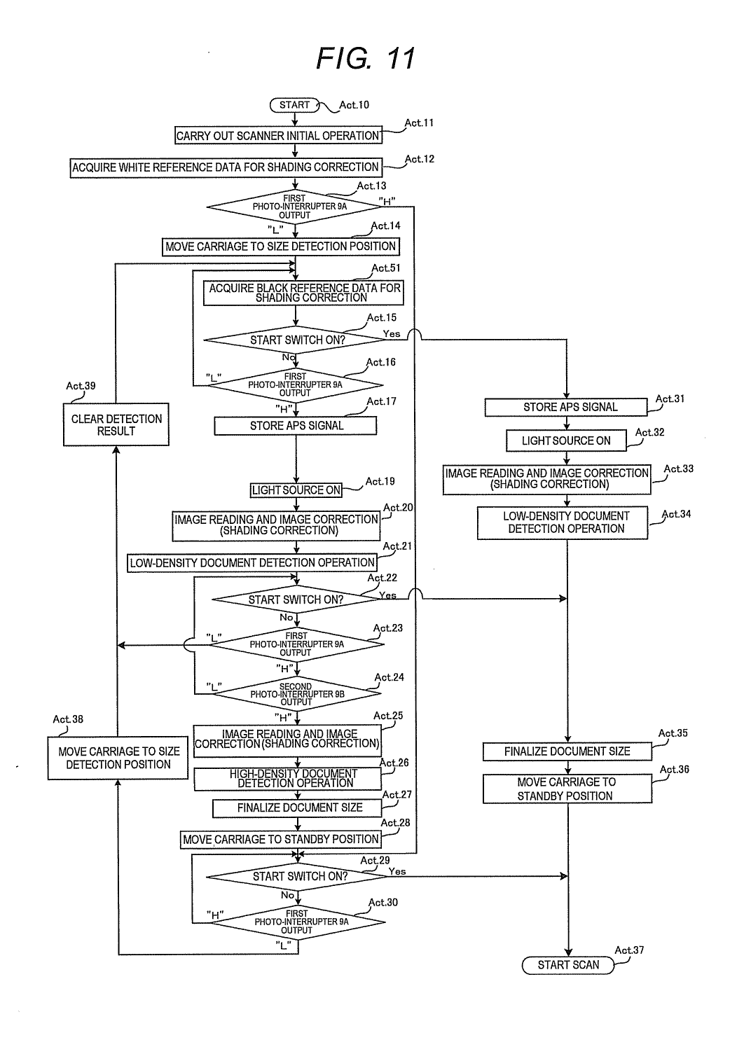

It should be noted that, as in a second embodiment shown in FIG. 11, the operation to acquire the black reference data for shading correction (Act 51) may be executed between Act 14 and Act 15 in FIG. 8, as the document detection processing, while Act 8 in FIG. 8 may be deleted.

Next, the operation to finalize the document size in Act 27 will be described with reference to FIGS. 9 and 10.

In FIG. 9, the vertical axis represents luminance value and the horizontal axis represents each measuring position (AP1 to AP5) . By way of example, it is assumed that a document of the AS size shown in FIG. 6 is placed at a predetermined position on the platen glass 3 and that the color of the document has a low density (high luminance).

When acquiring the black reference, the stop position of the carriage 71 is the size detection position. In the method for acquiring the black reference, the light source 303 is turned off . If the black reference is acquired at the size detection position, the black reference is acquired in the state where the platen cover 4 is half closed and therefore the influence of external light, if any, on the black reference data raises the level thereof. That is, the black reference level is low in luminance value up to AP1 to AP3 and the luminance value increases at AP4 to AP5.

FIG. 10 shows the result of carrying out shading correction based on the read data, the white reference data and the black reference data shown in FIG. 9, and a threshold used for detection.

Since the black reference value at a position where there is no document on the platen glass 3 is an equivalent level to external light, the luminance value (signal value) at the position where there is no document (AP4 to AP5) can be lowered to the luminance value of the black reference at the part where there is a document (AP1 to AP3) , with respect to the read signal. Therefore, the read signal has a large difference between the part with a document (AP1 to AP3) and the part without a document and therefore a threshold can be easily set.

Such processing enables reduction in the influence of external light around the platen glass 3 when carrying out detection of the document size.

Also, while, in FIG. 10, the black reference data is acquired with a change in the photo-interrupter (open-close operation of the platen cover 4), the processing of Act 20 to Act 21 is to read external light at the position where there is no document and therefore the operation cannot be done after the platen cover 4 is completed closed.

Thus, since the processing following the change in the photo-interrupter 9 increases, the operation to acquire the black reference data may not be completed before the platen cover 4 is completed closed, depending on the speed and angle at which the platen cover 4 is closed.

In such a case, the acquisition of the black reference data may be continued periodically in the state where the platen cover 4 is opened, as shown in Act 51 of FIG. 11 (Act 51, Act 15, Act 16). Consequently, the processing similar to the finalization of the document detection size shown in FIG. 10 can be achieved.

While the difference between the reference data for shading correction in document size detection and the reference data for shading correction in normal reading is not described in this embodiment, similar effects can be achieved by storing the reference data for shading correction in document size detection and in normal reading into the same memory (overwrite) or by storing the reference data for shading correction into separate memories.

The above detection operation enables reduction in the influence of surrounding light when carrying out document size detection on the scanner, and thus enables acquisition of highly accurate detection results.

The embodiment can be carried out in various other forms without departing from the spirit and primary features thereof. Therefore, the embodiment is simply an illustrative example in all respects and should not be interpreted as limiting. The scope of the invention is defined by the accompanying claims and not restricted by the above description. Moreover, all modifications, various improvements, alternatives and alterations that belong to the equivalents of the claims are within the scope of the invention.

1. An image reading device comprising:
a cover unit which is mounted in an openable and closable manner on a document table glass and holds a document on the document table glass while a scanner unit is moved in a sub scanning direction;
an open-close detection unit which detects opening and closing of the cover unit;
a document presence-absence detection unit which detects the presence or absence of a document in the sub scanning direction of the document placed on the document table glass;
a reference signal generation unit which generates a reference signal for shading correction used for normalization of an output signal from a line sensor which reads the document placed on the document table glass; and
a document size finalizing unit which finalizes a document size, based on a target to be detected based on the output signal in a document main scanning direction of the line sensor that is shading-corrected with the reference signal generated at a timing in the course of closure of the cover unit, and on document presence-absence information from the document presence-absence detection unit,
wherein the timing in the course of closure of the cover unit is when the open-close detection unit detects that the cover unit is not completely closed after detecting opening of the cover unit.

2. The device according to claim 1, wherein the state of the cover unit being in the course of closure is detected by the open-close detection unit.

3. The device according to claim 1, wherein the reference signal generated at the timing in the course of closure of the cover unit is a black reference signal.

4. The device according to claim 1, wherein, when finalizing the document size, if two or more types of reference signals are required for shading correction with respect to the output signal in the document main scanning direction from the line sensor, the respective reference signals are generated at different timings from each other.

5. The device according to claim 1, wherein the document size finalizing unit determines low density part as the target to be detected and high density part as other parts than the target to be detected, and determines the length in the main scanning direction of the document, based on a difference between these low-density and high-density parts.

6. The device according to claim 1, wherein the document size finalizing unit determines low density part as the target to be detected and high density part as other parts than the target to be detected, and determines the length in the main scanning direction of the document, based on a change in density in the other parts than the target to be detected.

7. The device according to claim 1, further comprising, separately, a memory which stores a reference signal used for a normal reading operation, and a memory which stores a reference signal used to detect the document size.

8. The device according to claim 1, further comprising a common memory which stores a reference used for a normal reading operation and a reference signal used to detect the document size.
